(19) United States
(12) Patent Application Publication
(10) Pub. No.: US 2011/0253074 A1
(43) Pub. Date: Oct. 20, 2011

(54) Locomotive Engine Emissions Control Suite

(76) Inventors: Mahesh Talwar, Somis, CA (US); Francois Bernard, New Hope, PA (US)

(21) Appl. No.: 12/759,890

(22) Filed: Apr. 14, 2010

(51) Int. Cl. F01P 7/14; F02G 5/00; F02M 69/04; F02P 5/04

(52) U.S. Cl. 123/41.1; 123/406.12; 123/557; 123/445

(57) ABSTRACT

A locomotive diesel engine emissions control suite includes retarding fuel injection timing and heating the diesel fuel. Switch locomotives are now required to comply with USEPA emission standards under 40 CFR Part 1033 regulations. Retarding the fuel injection timing reduces peak temperatures during combustion which in turn reduces production of Nitrogen oxides (NOx) but also increases emissions of particulate matter (PM), Carbon Monoxide (CO), and Hydrocarbons (HC) in the exhaust. Unrelated efforts to reduce the smoke in diesel exhaust by pre-heating the diesel fuel showed an unexpected reduction in PM, CO, and HC. Such heating of the diesel fuel did not affect the reduction in NOx but reduced emissions of PM, CO, and HC to acceptable levels. Further experiments showed that two degrees of fuel injection retarding and fuel heated to 120 to 140 degrees Fahrenheit resulted in meeting the 40 CFR Part 1033 regulations.

### BACKGROUND OF THE INVENTION

The present invention relates to the control of locomotive engines and in particular to reducing emission levels of switch locomotives to comply with USEPA emission standards under 40 CFR Part 1033 regulations which became effective in January 2010.

USEPA emission standards under 40 CFR Part 1033 became effective in January 2010. These standards include:

Nitrogen oxides (NOx)=11.8 gms/bhp-hr;

Hydrocarbons (HC)=2.1 gms/bhp-hr;

Carbon Monoxide (CO)=8 gms/bhp-hr;

Particulate matter (PM)=0.26 gms/bhp-hr; and

Smoke opacity=30/40/50

The above standards are also known as Tier 0 plus standards.

Switch locomotives commonly use an Electro Motive Division (EMD) 645 series engine. The 645 series engines are a family of eight, twelve, sixteen and twenty cylinder 45 degree Vee two stroke diesel engines used as locomotives, marine, and stationary engines. Each engine includes the same bore and stroke producing 645 cubic inches per cylinder, and include a roots blower or a turbocharger. The 645 series engines have been replaced by 710 series engines, but are still in use, for example, in the switching locomotives.

Two stroke diesel engines include exhaust valves in the head(s) and intake ports low in the cylinder walls which are covered by the pistons during most of an engine cycle and briefly uncovered to allow air to enter the cylinder. The exhaust valves are opened by a cam(s) when the piston nears Bottom Dead Center (BDC) at the end of the power stroke and close after the intake ports are uncovered by the piston, resulting in both the exhaust valves being open and the intake ports uncovered at the same time. The two stroke diesels require a supercharger to force air through the intake ports and into the engine because there is no vacuum to draw air into the cylinder. The piston again covers the intake ports shortly after beginning the compression stroke. Fuel is injected into the engine near Top Dead Center (TDC) and is ignited by heat in the cylinder at the beginning of the power stroke. Such diesel engines would be less efficient than gasoline engines, except for the fact that because the diesel fuel is not in the cylinder during the compression stroke, a higher compression is useable with a diesel engine than a gasoline engine, and the thermal efficiency of the engine increases with compression ratio.

Various methods have been exercised to reduce the emissions of locomotives using the EMD 645 series engines. Unfortunately, while known methods address some of the Tier 0 standards, the known methods have failed to address all of the standards.

### BRIEF SUMMARY OF THE INVENTION

Various aspects of the present invention address the above and other needs by providing a locomotive diesel engine emissions control suite which may be applied to existing in-use Electro Motive Division (EMD) 645 series engines to meet the USEPA emission standards under 40 CFR Part 1033 regulations. Switch locomotives are now required to comply with USEPA emission standards under 40 CFR Part 1033 regulations. The locomotive diesel engine emissions control suite includes retarding fuel injection timing and heating the diesel fuel which allows the switch locomotives to meet the 40 CFR Part 1033 regulations.

In accordance with one aspect of the invention, there is provided an emissions control suite which includes retarding fuel injection timing and heating the diesel fuel. Retarding the fuel injection timing reduces peak temperatures during combustion which in turn reduces production of Nitrogen oxides (NOx) but also increases emissions of Particulate Matter (PM), Carbon Monoxide (CO), and Hydrocarbons (HC) in the exhaust. Unrelated efforts by the present inventors to reduce the smoke in diesel exhaust by pre-heating the diesel fuel showed an unexpected reduction in PM, CO, and HC. Such heating of the diesel fuel is expected to increase combustion temperature and thus NOx, but unexpectedly, a substantial increase in fuel temperature, from 75 degrees Fahrenheit to as much as 140 degrees Fahrenheit did not defeat the reduction in NOx provided by the retarded fuel injection timing, but did reduce PM, CO, and HC emissions to satisfy 40 CFR Part 1033 regulations. Further experiments showed that an unexpected synergistic combination of two degrees of fuel injection retarding and fuel heated from a typical 95 degrees Fahrenheit to approximately 140 degrees Fahrenheit resulted in meeting the 40 CFR Part 1033 regulations. The temperature of the heated diesel fuel must be carefully controlled to not exceed approximately 140 degrees Fahrenheit which is approaching the flash point of the diesel fuel.

In accordance with yet another aspect of the invention, there is provided an emissions control suite which reduced emissions in diesel engines having a compression ratio between 14.5 to 1 and 16 to 1, and as high as 17.4 to 1 or higher.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a diagram of the emissions control suite according to the present invention.

FIG. 2 shows a diesel engine including the emissions control suite according to the present invention.

FIG. 3 is a diagram of a fuel heating element of an emissions control suite according to the present invention including an AMOT self powered 3-way Thermostatic Valve.

FIG. 4 is a diagram of a second fuel heating element of an emissions control suite according to the present invention including a fuel temperature sensor and a sensor controlled.

Corresponding reference characters indicate corresponding components throughout the several views of the drawings.

### DETAILED DESCRIPTION OF THE INVENTION

The following description is of an embodiment presently contemplated for carrying out the invention. This description is not to be taken in a limiting sense, but is made merely for the purpose of describing one or more preferred embodiments of the invention, and other embodiments derived by those skilled in the art are intended to come within the scope of the present invention. The scope of the invention should be determined with reference to the claims.

Reduction of engine emissions have proven to be very difficult due to the complex nature of combustion in engines. Methods have generally consisted of trial and error and lack accurate models capable of predicting results. Further, emissions reduction is generally a non-linear multi-dimensional problem including the interaction of fuel control, air intake control, engine bore and stroke, combustion chamber design, operating temperatures, and other design and operation parameters. The overall environment of engine emissions control thus presents a complex problem with few obvious solutions when a single parameter is varied, and virtually no obvious solution when multiple interacting parameters are varied.

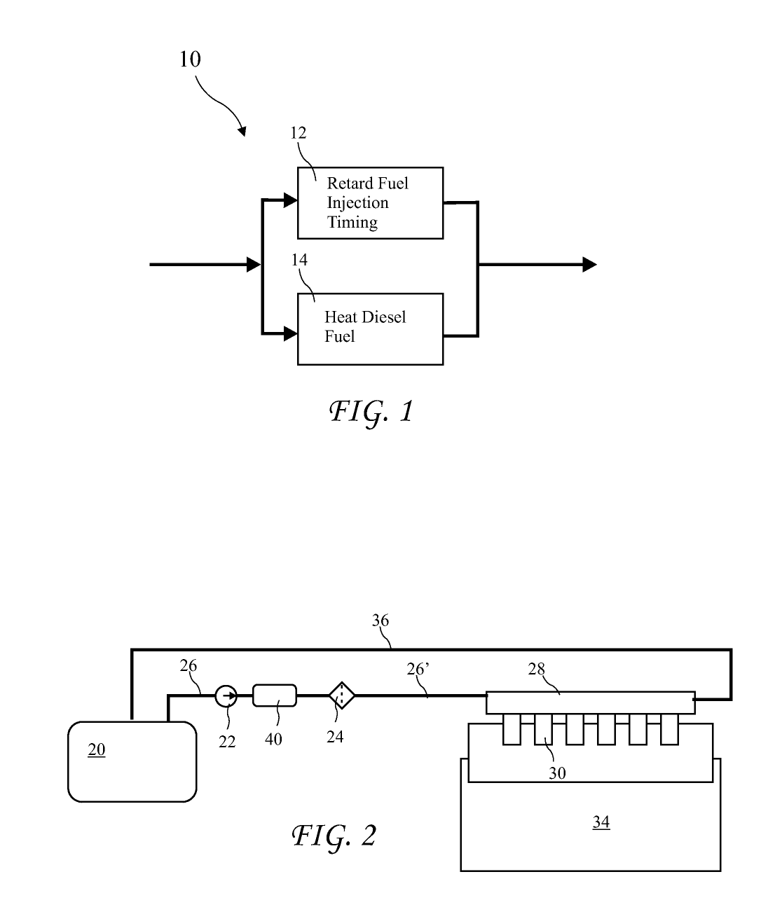

An example of an emissions control suite 10 according to the present invention is shown in FIG. 1. The emissions control suite 10 may be retrofitted to an existing in-use Electro Motive Division (EMD) 645 series engines of a switching locomotive to meet recently enacted USEPA emission standards under 40 CFR Part 1033 regulations. The emissions control suite 10 includes two elements, a fuel injection retard element 12 and a heat diesel fuel element 14. The combination of retarding the fuel injection and heating the diesel fuel unexpectedly allows the diesel engine to meet the 40 CFR Part 1033 regulations.

The fuel injection retard element 12 comprises retarding the fuel injection timing to delay the injection of diesel fuel to reduce the peak combustion temperature. NOx is created when nitric oxide (NO) reacts with oxygen (O₂) to create nitrogen dioxide (NO₂). The lower peak combustion temperature reduces the chemical reaction reducing the production of NOx. Unfortunately, retarding the fuel injection timing also increased the emissions of particulate matter (PM), Carbon Monoxide (CO), and Hydrocarbons (HC). Preferably, the fuel injection timing is retarded by approximately two degree of crankshaft rotation to obtain the desired reduction in NOx. For example, a common fuel injection timing of four degrees Before Top Dead Center (BTDC) is preferably retarded to two degrees BTDC to delay the injection two degrees of crankshaft rotation.

There were no obvious methods for reducing the increased PM, CO, and HC in the diesel engine exhaust. However, an independent effort was underway to reduce smoke in the exhaust. One approach to smoke reduction which was tried was to heat the diesel fuel to provide more complete combustion. The engine exhaust was being monitored as part of the test, and an unexpected reduction in PM, CO, and HC was observed. Bases on these unexpected results, further tests were performed with different levels of fuel heating and a successful combination for fuel injection retard and fuel heating was discovered which satisfied the 40 CFR Part 1033 regulations.

A diesel engine 34 including the emissions control suite 10 according to the present invention is shown in FIG. 2. Unheated diesel fuel 26 is drawn from a fuel tank 20 by a low pressure pump 22. The unheated fuel 26 is provided to a fuel heater 40. The fuel heater 40 heats the fuel to provide heated fuel 26′. The heated fuel 26′ passes through a filter(s) 24 and into a fuel manifold 28 at between approximately 40 and 60 PSI. The fuel system is a flow through system with a return flow 36. Fuel injectors 30 are fed from the fuel manifold 28 and are actuated by a camshaft and injector rocker arms which creates the high pressure required for the diesel fuel injection. Typically, a mechanical rack actuated by a governor controls the high pressure injection of fuel into the combustion chambers, however, one will appreciate that other means may be used to deliver fuel into the combustion chambers. The operation of the injectors 30 is well known to those skilled in the art and is not described here in further detail.

No immediate solution to the increased PM, CO, and HC emissions resulting from retarding fuel injection timing was known, but an unrelated parallel effort was underway to reduce diesel engine smoke. One approach to reducing smoke which was tested was heating the diesel fuel to improve combustion. An unexpected result of heating the diesel fuel was that PM, CO, and HC emissions were reduced. Once this reduction was identified, additional experiments were performed with varying fuel injection retarding and fuel heating. Test results eventually showed that in various embodiments of the present invention two degrees of fuel injection retarding coupled with heating the fuel to between 120 and 140 degrees Fahrenheit, and preferably near the 140 degrees Fahrenheit flash point of the diesel fuel, provided consistently good results meeting the 40 CFR Part 1033 regulations.

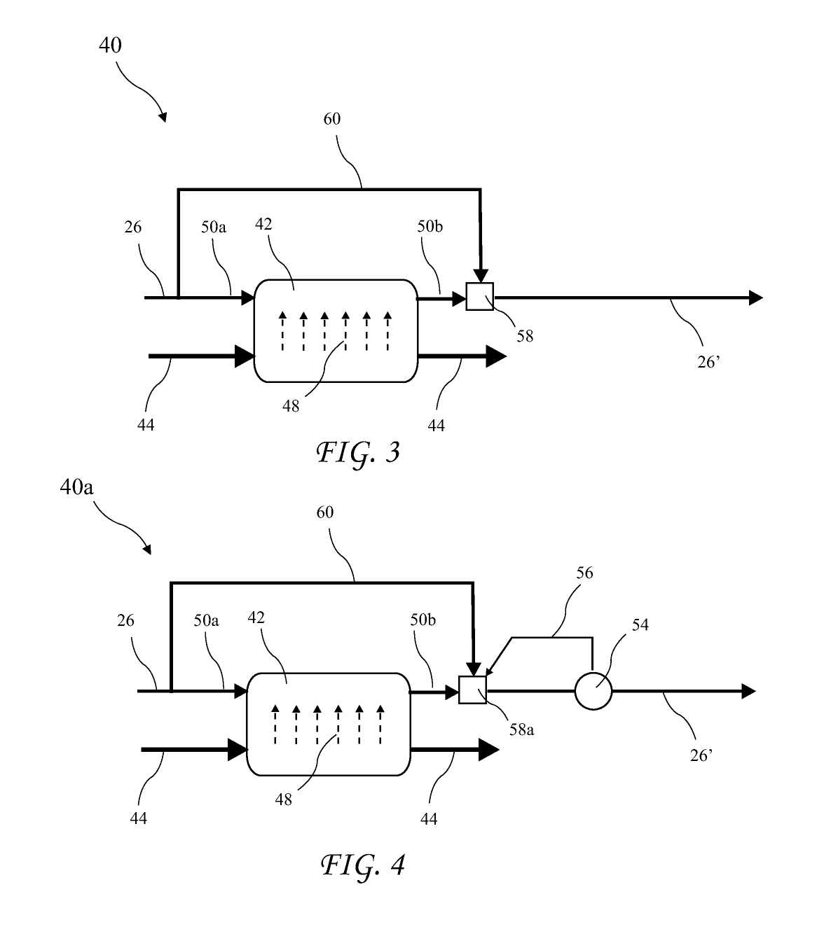

A diagram of a preferred heat diesel fuel element 14 of the emissions control suite 10 is shown in FIG. 3. The heat diesel fuel element 14 includes a heat exchanger 42 transferring heat 48 from a heated engine coolant flow 44 to a pre heat exchanger fuel flow 50a. Such heat transfer 48 provides a reliable and inexpensive source of heat. The flow of diesel fuel 26 is split between the pre heat exchanger fuel flow 50a into the heat exchanger 42 and a bypass flow 60 around the heat exchanger 42. The transferred heat 48 raises the temperature of the pre heat exchanger fuel flow 50a to provide a heated fuel flow 50b at an elevated temperature. The heated fuel flow 30b is combined with the bypass flow 32 by a valve 58 to provide a heated fuel flow 26′ to the diesel engine injectors 30. A flow control valve 58 regulates the combining the heated fuel flow 50b with the bypass flow 60 to control the temperature of the heated fuel flow 26′. The temperature of the heated fuel flow 26′ is preferably maintained between 120 and approximately 140 degrees Fahrenheit and is more preferably approximately 140 degrees Fahrenheit. Alternatively, the temperature of the heated fuel flow 26′ is maintained just below the flash point of the diesel fuel.

The flow control valve 58 is preferably a powered 3-way thermostatic valve which includes internal temperature regulating features to control the combining the heated fuel flow 50b with the bypass flow 60 to control the temperature of the heated fuel flow 26′. An example of a suitable flow control valve 58 is a AMOT self powered 3-way Thermostatic Valve with a target temperature designed into the valve.

A diagram of a second fuel heating element 40a of the emissions control suite according to the present invention is shown in FIG. 4. The fuel heating element 40a includes a fuel temperature sensor 54 and a sensor controlled 3-way valve 58a. The temperature of the heated fuel flow 26′ is measured by sensors 54 and a control signal 56 is used to control the flow control valve 58a regulating the combining the heated fuel flow 50b with the bypass flow 60 to control the temperature of the heated fuel flow 26′. Alternative, the valve 58a may be a 2-way valve controlling only the bypass flow 60 or the heated fuel flow 50b to control the heated fuel flow 26′.

The amount of fuel injection timing retard and fuel heating disclosed above is based on results obtained for a limited variety of diesel engines. Other diesel engines include different types and methods of forced induction which often affect the temperature of air entering the engine and other engine parameters. As a result, variations to the amount of fuel injection timing retard and fuel heating disclosed here for the 645 series engines, to obtain similar reductions in emissions in other diesel engines, are intended to come within the scope of the present invention.

Additional engine modifications may enhance engines including the locomotive diesel engine emissions control suite. For example, the use of low oil consumption cast iron or stainless steel ring sets may be used to reduce oil consumption. Additionally, plateau honing the liners (thereby increasing the bearing area of the liner while maintaining oil retention) and plating the pistons with tin have shown potential advantages.

While the invention herein disclosed has been described by means of specific embodiments and applications thereof, numerous modifications and variations could be made thereto by those skilled in the art without departing from the scope of the invention set forth in the claims.

I claim:

1. An emissions controlled locomotive diesel engine comprising:
a locomotive;
a diesel engine installed in the locomotive, the diesel engine providing power for motion of the locomotive;
diesel fuel injection having retarded timing; and
diesel fuel heated before injection into the diesel engine.

2. The emissions controlled locomotive diesel engine of claim 1, wherein the diesel fuel injection timing is retarded approximately two degrees.

3. The emissions controlled locomotive diesel engine of claim 1, wherein the diesel fuel is heated to between 120 and 140 degrees Fahrenheit before injection into the diesel engine.

4. The emissions controlled locomotive diesel engine of claim 3, wherein the diesel fuel is heated to approximately 140 degrees Fahrenheit before injection into the diesel engine.

5. The emissions controlled locomotive diesel engine of claim 1, wherein the diesel fuel is heated to just below the flash point of the diesel fuel before injection into the diesel engine.

6. The emissions controlled locomotive diesel engine of claim 1, wherein the diesel fuel heater includes a diesel engine coolant to diesel fuel heat exchanger.

7. The emissions controlled locomotive diesel engine of claim 6, wherein the diesel engine coolant is split between a heated fuel flow through the coolant to diesel fuel heat exchanger and a bypass flow around the coolant to diesel fuel heat exchanger, providing control of diesel fuel temperature.

8. The emissions controlled locomotive diesel engine of claim 6, wherein the temperature of a heated fuel flow from the diesel fuel heater is controlled by controlling the combination of the diesel fuel heated in the diesel fuel heat exchanger with diesel fuel bypassing the heat exchanger.

9. The emissions controlled locomotive diesel engine of claim 8, wherein a thermostatic valve controls the combination of the diesel fuel heated in the diesel fuel heat exchanger with diesel fuel bypassing the heat exchanger.

10. The emissions controlled locomotive diesel engine of claim 1, wherein the diesel engine is a Electro Motive Division (EMD) 645 series engine.

11. The emissions controlled locomotive diesel engine of claim 10, wherein the fuel injection timing is retarded from four degrees Before Top Dead Center (BTDC) to two degrees BTDC.

12. The emissions controlled locomotive diesel engine of claim 1, wherein the diesel engine has a compression ratio of approximately 17.4 to 1.

13. An emissions controlled locomotive diesel engine comprising:
a locomotive;
a Electro Motive Division (EMD) 645 series engine installed in the locomotive, the EMD 645 series engine providing power for motion of the locomotive;
a fuel tank containing diesel fuel for combustion in the EMD 645 series engine;
a fuel injection system including fuel injectors providing the diesel fuel to corresponding cylinders of the EMD 645 series engine;
a cam operating the fuel injectors to control the timing and amount of the diesel fuel injected into the cylinders, the timing of the cam retarded approximately two degrees from standard fuel injection timing to reduce NOx emissions;
a fuel system delivering the diesel fuel from the fuel tank to a fuel injection manifold in fluid communication with the fuel injectors;
a heat exchanger receiving a flow of heated engine coolant and transferring heat from the heated engine coolant to a flow of the diesel fuel from the fuel tank to the injector manifold;
a diesel fuel bypass around the heat exchanger carrying an unheated flow of the diesel fuel from the fuel tank to the injector manifold; and
a 3-way thermostatic valve controlling the combination of the diesel fuel heated in the heat exchanger with diesel fuel bypassing the heat exchanger to control the temperature of the diesel fuel provided to the fuel injectors to be approximately 140 degrees Fahrenheit.

14. A method to reduce emissions of a diesel engine, wherein the diesel engine includes individual fuel injectors providing fuel from a fuel supply to corresponding cylinders, the method comprising:
retarding fuel injection timing to reduce emissions of NOx from the engine; and
heating a temperature of fuel supplied by the fuel injectors to above 120 degrees Fahrenheit to reduce Particulate Matter (PM), Carbon Monoxide (CO), and Hydrocarbons (HC) from the engine.

15. The method of claim 14, wherein the fuel injection timing is retarded is approximately two degrees.

16. The method of claim 14, wherein the fuel supply is heated using a heat exchanger and heat from an engine coolant.

17. The method of claim 16, wherein the level of heating of the fuel supply by the heat exchanger is controlled using a thermostatic valve combining a heated fuel flow through the heat exchanger with an unheated fuel flow through a bypass around the heat exchanger.

18. The method of claim 17, wherein the thermostatic valve is configured to provide fuel at a temperature of approximately 140 degrees Fahrenheit to the fuel injectors.

19. The method of claim 17, wherein the thermostatic valve is configured to provide fuel at a temperature just below the flash point of the diesel fuel to the fuel injectors.
